(19) United States
(12) Patent Application Publication
(10) Pub. No.: US 2025/0269681 A1
(43) Pub. Date: Aug. 28, 2025

(54) WHEEL COMPONENT FOR A BICYCLE

(71) Applicant: DT SWISS INC., Grand Junction, CO (US)

(72) Inventors: Martin WALTHERT, Aarberg (CH); Andreas HENIG, Biel (CH); Christian GARTHAUS, Dresden (DE)

(21) Appl. No.: 19/059,655

(22) Filed: Feb. 21, 2025

(30) Foreign Application Priority Data
Feb. 22, 2024 (DE) 102024105066.7

(51) Int. Cl. B60B 1/04

(52) U.S. Cl. CPC B60B 1/041; B60B 2360/341

(57) ABSTRACT

A wheel component for bicycles with a straight spoke, with a center portion and two end portions, to detachably connect a hub with a rim. The spoke is supported on a hub and a rim by the end portions. The spoke is manufactured from a fibrous composite material and includes a matrix material and embedded reinforcing elements. The spoke is formed without loops and eyelets. The end portions are integral with the center portion, forming an end of the spoke each. At least one of the two end portions includes a threaded portion. At least some of the reinforcing elements are configured as long fibers extending through the entire center portion and over at least a substantial part of the two end portions each. At least one end portion includes a cross-sectional region with embedded reinforcing long fibers, and at least one cross-sectional portion without reinforcing embedded long fibers.

### BACKGROUND

The present invention relates to a wheel component for a vehicle, and, in particular, for a two- or multi-wheel vehicle such as a bicycle, which in proper normal or standard operation is at least partially muscle-powered, and comprises a spoke, which comprises a center portion and two end portions, to detachably connect the spoke with a hub of a wheel or a rim of a wheel, respectively. The spoke is manufactured from at least one fibrous composite material and comprises a matrix material and reinforcing elements embedded therein.

The prior art has disclosed various wheel components for bicycles and the like, comprising separate spokes. The spokes used tend to be of metal, mostly manufactured of steel, and comprising on one of the ends a cranked head, and on the other of the ends, a thread. This enables retaining the spoke for example on the hub at the cranked end, while the threaded end is retained on a spoke nipple on the rim. Screw-fixing the spoke nipple sets and adjusts a suitable spoke tension and to center the wheel. These wheels with metallic spokes have been known for a long time, and offer a reliable performance. There is the desire, however, to reduce the weight of bicycle wheels.

Wheels from a fibrous composite material for bicycles have been disclosed, wherein the spokes are manufactured directly together with the rim. Although these wheels may have a low weight, they are complex in manufacturing, and cannot be readily serviced. Even in the case of minor defects, the entire wheel must be exchanged as a rule, which is not very sustainable.

U.S. Pat. No. 5,350,221 has disclosed a separate spoke from a fibrous composite material manufactured by injection molding. A short-fiber fibrous composite material is injected into the cavity of a manufacturing mold, so that the fibrous material is homogeneously distributed in the mold cavity. One of the spoke ends has a cranked head and the other of the ends, a thread for screwing to a spoke nipple. Such a spoke has not found acceptance in the market in the past decades. The same document also describes a spoke where metallic ends are employed, so that the power-transmitting points on the spoke are manufactured of a metal.

EP 3 459 759 B1 discloses a spoke from a fibrous composite material, wherein the spoke body is manufactured by pultrusion. The spoke body is provided with stepped surfaces and inclined regions, onto which sleeves are pushed, which consist, in particular, of stainless steel and establish a connection with the hub and the rim, respectively. Although such a spoke is basically functional, its manufacture is complex.

WO 03/020535A2 has disclosed a fiber-reinforced spoke for a bicycle wheel comprising a longitudinal spoke body, onto which sleeves are pushed, before the spoke body ends are thickened to thus retain the separate sleeves on the spoke body. The sleeve provided for fastening the spoke to the rim has a spherical support to enable alignment of the spoke. The sleeve at the other end comprises an external thread for screwing the spoke to a hub having a matching thread. The spoke body is manufactured by pultrusion. This spoke is likewise functionally satisfactory and enables a low weight. What is a drawback is the considerable manufacturing complexity.

It is therefore the object of the present invention to provide a wheel component with a spoke, which is easier in manufacturing and has a low weight and high stability under load.

### SUMMARY

A wheel component according to the invention for a vehicle and, in particular, a bicycle includes a spoke configured straight (and elongated) with a center portion and two end portions, to detachably connect the spoke with the hub (of a wheel) and with the rim (of the wheel) by means of the end portions. At least one of the two end portions comprises a threaded portion. The spoke is manufactured from at least one fibrous composite material and comprises at least one matrix material with reinforcing elements embedded therein. The spoke is, in particular, smooth (on the surface) and, in particular, (completely) without loops and/or eyelets. The end portions are configured integrally with the center portion, forming one spoke end each. The threaded portion (a thread) is formed integrally with the end portion. The threaded portion is formed in one piece with the end portion. At least some of the reinforcing elements are configured as long fibers, extending through the entire center portion and over at least a substantial part of the two spoke end portions. At least one end portion comprises a cross-sectional region with long fibers embedded therein as reinforcing elements and at least one cross-sectional portion without long fibers embedded therein as reinforcing elements.

The wheel component according to the invention has many advantages. A considerable advantage of the wheel component according to the invention consists in providing a lightweight and readily manufactured wheel component which is very robust.

The end portions configured integrally with the center portion enable high stability under load and prevent settling phenomena, which may show in multipart spokes. It can adversely affect the spoke tension and the centering of wheels. The invention prevents this.

The spoke according to the invention may substantially be manufactured by pultrusion, wherein the end portions or parts thereof are integrally injected with the center portion, while the matrix material of the center portion is still liquid, or after re-liquefying it. Thus, a one-piece wheel component is made, wherein even the spoke interior does not show any gluing, adhesive layers or separating boundary layers. It is conceivable that microscopic boundary layers or rather, boundary regions are recognizable. At any rate, there is no separate intermediate layer such as an adhesive layer.

The spoke, in particular, has a spoke body configured straight and elongated, comprising a center portion and end portions integrally configured on its two opposite ends and remote from one another. The spoke is configured straight, not showing any cranking.

The spoke body preferably comprises no through holes or recesses where other parts can be hooked in. Apart from the thread or the threads, the surface of the end pieces or connecting elements is preferably smooth and has no hooks or eyes.

At least some of the long fibers extend completely (i.e. continuously or “endlessly”) through the spoke. The long fibers extend through the middle portion and over at least a substantial part of both end portions. That means, that a plurality of long fibers each extend through the middle portion and both end portions. The long fibers extend in a cross-sectional region of the spoke through the middle portion and (at least a substantial part of) both end portions.

The long fibers employed are long reinforcing fibers and for example continuous fibers, which are for example trimmed to the spoke length, following pultrusion. Succinctly put, long reinforcing fibers may also be referred to as long fibers in the scope of this application. The spokes can transmit high tensile forces. The long fibers, which (practically) extend from one end of the spoke to the other, contribute significantly to this. In preferred embodiments, (almost) every long fiber extends completely through the spoke.

In a preferred specific embodiment, at least one end portion has an outer diameter that is larger than at least one transverse dimension in the center portion. In particular, at least one outer diameter of an end portion is larger than a minimum transverse dimension and/or a medium transverse dimension and/or a maximum transverse dimension in the center portion.

A transverse dimension is understood to mean a dimension oriented transverse respectively perpendicular to the longitudinal axis or axis of symmetry of the spoke. In simple configurations, the transverse dimension may be the diameter in a central region of the center portion.

In a preferred embodiment, at least one end portion and, in particular, at least the head portion has a conical portion adjacent to the center spoke portion and a support portion in turn adjacent thereto. The conical portion may be located directly or indirectly adjacent to center spoke portion. The conical portion, manufactured integrally with the entire spoke body, together with the support portion, provides a reliable spoke support.

Preferably, at least one of the end portions has a threaded portion (with a thread) for screwing to a spoke nipple. Preferably, at least one of the end portions has a head portion for supporting the spoke. It is possible and particularly preferred for one of the end portions to comprise a head portion for a spoke support and the other of the end portions, a threaded portion for screwing to a spoke nipple.

Alternately it is also possible for head portions to be configured on both ends. Alternately, for threaded portions to be configured on both ends.

It is also possible for both ends to comprise a head portion and configured thereat, a threaded portion. Then, e.g. both ends may comprise a thickening as the head portion, with a cylindrical, threaded portion configured on the head portion. This enables flexibility of use.

In advantageous specific embodiments, at least one end portion comprises a cross-sectional region with long fibers embedded as reinforcing elements, and at least one cross-sectional portion with shorter reinforcing elements embedded therein. The shorter reinforcing elements are configured shorter than the longer reinforcing elements respectively long fibers. Particularly preferably, the shorter reinforcing elements are shorter than ⅕ or 1/10 of the long fiber lengths. The long fiber length, in particular, or substantially corresponds to approximately the spoke length and reaches or exceeds at least 90% or 95% or 99% of the entire spoke length. Preferred variants of shorter reinforcing elements, which are configured as fibers, may be referred to as short fibers in the scope of this application.

It is possible for the cross-sectional portion to be configured free of long fibers. It is preferred for the cross-sectional portion to comprise a smaller proportion of long fibers than the cross-sectional region. Particularly preferably, the central region of the center portion is a cross-sectional region with (solely) long fibers as reinforcing elements. Since the long fibers basically extend through the entire spoke, long fibers also show at the ends (in or around the center).

Preferably, at least part of the reinforcing elements is formed by short fibers which are configured considerably shorter than the long fibers.

A cross-sectional region may also be referred to as a long fiber region, and a cross-sectional portion may also be referred to as a short fiber region. Short fibers are, in particular, understood to mean reinforcing fibers having a length between 0.1 mm or 0.2 mm and approximately 3 cm. Particularly preferably, short fibers are shorter than 10 mm.

Preferably, a considerable part of the cross-sectional region includes solely long fibers as reinforcing elements. Preferably, a considerable part of the cross-sectional portion includes solely no reinforcing elements or only very few reinforcing elements or comprises shorter reinforcing elements (for example in the shape of short fibers). The cross-sectional region and the cross-sectional portion (at least at one longitudinal point) each have a considerable share of the (total) cross-section of the spoke. The cross-sectional portion can form at least 5% or at least 10% or even 20% or 30% or more of the cross-sectional area of the spoke at at least one end piece.

At the middle portion, (substantially or almost all of) the cross-sectional area can be formed by the cross-sectional portion. A share of the cross-sectional area of the spoke at at least one point in the center portion is preferably over 75% and, in particular, over 80% or over 90% or 95% or more. The long fibers are preferably homogeneously distributed in the cross-sectional region.

In preferred configurations, at least a part of the shorter reinforcing elements is formed by fiber bits and/or reinforcing particles. Fiber bits are, in particular, two-dimensional elements. Reinforcing particles may be spherical elements, powder particles, or uneven particles.

It is also possible that the cross-sectional portion comprises only a small amount of reinforcing elements, so that a weight proportion of reinforcing elements in the cross-sectional portion is much smaller than a weight proportion of reinforcing elements in the cross-sectional region. There may be a small (or smaller) amount of shorter reinforcing elements in the cross-sectional region. It is also possible that there are almost no reinforcing elements or none at all in the cross-sectional region.

In particularly preferred configurations, the cross-sectional portion comprises the same matrix material as the cross-sectional region. This means, in particular, that the same or the identical matrix material is employed in the short fiber region and in the long fiber region. Then this means that the matrix material of the spoke is preferably uniform.

Thus, the same matrix material respectively the same type of matrix material may be employed in the entire spoke. Optionally it is also possible to use slightly different matrix materials, wherein the basic components of the matrix material are particularly preferably identical.

It is likewise preferred for the material of the reinforcing elements of the spoke is uniform overall. However, it is possible and preferred for the material of the reinforcing elements in the cross-sectional portion to differ at least partially from the material of the reinforcing elements in the cross-sectional region. The difference does not only show in shape and size but also in the type and composition of the material employed. In particular, at least part of the shorter reinforcing elements may consist of a different material than do the long fibers. Thus, for example carbon fibers may be employed for the long fibers, while glass fibers are employed as short fibers, or glass particles for example in the thread region. Preferably, at least part of the shorter reinforcing elements comprise glass fiber material.

In particularly preferred configurations, the spoke is configured of a single material. Particularly preferably, the spoke body volume does not comprise any concrete material boundary surfaces, as they show for example when gluing or welding together two separate workpieces.

Preferably, the cross-sectional region (long fiber region) has, in at least one end portion, a cross section deviating from a rotationally symmetrical cross section. Thus, it is preferred for an envelope of the long fibers to have a cross section in the cross-sectional region deviating from a rotationally symmetrical cross section. An “envelope” is understood to mean an “envelope curve” or a (virtual) shape bearing the closest possible against the reinforcing elements. The envelope curve only indicates the structure but it is not a real layer.

In all the specific embodiments and configurations it is preferred for the deviating cross section to have a shape taken from a group of shapes comprising (approximately) a polygonal, star-, oval, elliptic or cone- or T- or L- or H-shape, optionally with rounded corners. These configurations reliably ensure the transmission of a higher rotational force, which may develop when fastening or adjusting the spoke.

Generally, when mounting spokes in a wheel, the spokes are subjected to tensile stress such that in regular operation, there will always be tensile stress in the spoke in any loads occurring.

In one configuration, the cross-sectional portion is preferably accommodated centered in the end portion and has a cone-like portion. Then it is possible for long fibers to surround the cone-like portion all-round in the end portion.

Preferably, the cross-sectional portion radially surrounds the cross-sectional region (long fiber region), and the cross-sectional portion forms a thickening at the end portion.

Particularly preferably, the threaded portion is configured in the cross-sectional portion (with shorter reinforcing elements).

Particularly preferably, the long fibers extend through a central region of the center portion and through at least one central region of an end portion. With the threaded portion, the end portion may comprise a central region, through which the long fibers extend, and a ring area, in which the thread is integrated and in which the shorter reinforcing elements are incorporated.

In all the configurations it is particularly preferred for the cross-sectional region to comprise a thermoplastic matrix material. Particularly preferably, the entire spoke body comprises a thermoplastic matrix material. Particularly preferably, (only) at least one thermoplastic matrix material is used as the matrix material in the spoke body. A spoke is preferably manufactured (mainly) by pultrusion with a thermoplastic matrix material. The spoke is cut to length. The end portions may also be called end parts or end pieces. The end portions thereof are injection moulded onto the middle portion. The middle portion can also be called the center piece or center portion. The end portions are injection molded with (a similar or identical) thermoplastic matrix material while the matrix material of the center portion is still liquid or after it has been (warmed up and) re-liquefied.

Another wheel component according to the invention, of a vehicle and, in particular, a bicycle, is, in particular, provided for proper normal or standard operation of at least partially muscle-powered two- or multi-wheel vehicles, and comprises a rim and a hub and separate spokes configured straight. At least one spoke comprises a center portion and two opposite end portions remote from one another. The hub is detachably connected with the rim through the end portions through the spokes. At least one of the end portions may comprise a head portion (spoke head), and at least one of the end portions may comprise a threaded portion, which is screw-connected with a thread on a spoke nipple. The spoke respectively the spoke body of the spoke is manufactured from at least one fibrous composite material and comprises at least one matrix material and reinforcing elements embedded therein. The end portions are integrally configured with the center portion, each forming one spoke end. At least some of the reinforcing elements are configured as long fibers (long reinforcing fibers), extending through the entire center portion and over at least a substantial part of the two end portions each.

This wheel component according to the invention again has many advantages.

Preferably, the spoke center portion is aerodynamic in shape. This enables a reduced air drag, given a low weight. Preferably, the end portion is accommodated in the spoke at least nearly completely, or completely within the rim. This enables a particularly advantageous configuration, wherein the aerodynamic center portion extends up to the rim. A transition region is not required. Since the highest relative speeds relative to the surroundings specifically occur in the radially outermost region of the spoke on the rim, an aerodynamic configuration is particularly advantageous in this point. The invention enables this.

Preferably, at least one spoke nipple from a fibrous composite material is employed and screw-connected with the spoke. Particularly preferably, all the spokes and all the spoke nipples are manufactured from a fibrous composite material.

Particularly preferably, the rim material and also the hub housing material comprises a fibrous composite material and/or metal.

Further advantages can be taken from the exemplary embodiments which will be discussed below with reference to the enclosed figures.

### BRIEF DESCRIPTION OF THE DRAWINGS

The figures show in:

FIG. 1 a schematic illustration of a racing bicycle;

FIG. 2 a schematic illustration of a mountain bike;

FIGS. 3-7 schematic sectional views of spokes;

FIGS. 8-10 side views and a perspective view of a spoke; and

FIGS. 11-13 schematic views of a spoke nipple.

### DETAILED DESCRIPTION

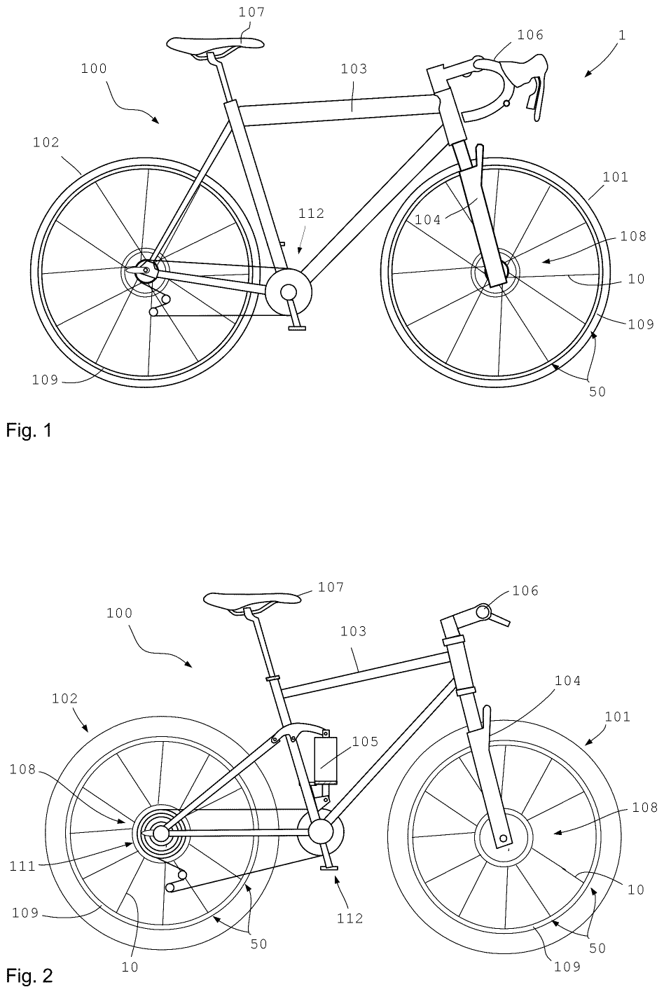

FIGS. 1 and 2 show a mountain bike and a gravel bicycle or racing bicycle 100 respectively, which are each equipped with wheel components 1 according to the invention. The mountain bike or racing bicycle 100 is provided with a front wheel 101 and a rear wheel 102.

The two wheels 101, 102 are provided with spokes 10. A sprocket device 111 is provided. Basically, conventional caliper brakes or other brakes, for example disk brakes may be provided.

The bicycles 100 are each provided with a frame 103, a handlebar 106, a saddle 107, a fork or suspension fork 104 respectively, and in the case of the mountain bike or a racing bicycle or gravel bicycle (gravel bike), a rear wheel damper 105 may be provided. A pedal crank 112 with pedals serves for driving. Optionally the pedal crank 112 and/or the wheels may be provided with an electric auxiliary drive. The hubs of the wheels may be attached to the frame by means of a clamping mechanism such as a through axle or a quick release.

The FIGS. 1 and 2 show the wheel component 1 according to the application with spokes 10 and spoke nipples 50. The spokes connect the hub 108 with the rim 109. The spoke nipples 50 shown are accommodated in the interior of the hollow rim 109, so as to be not visible in the side view.

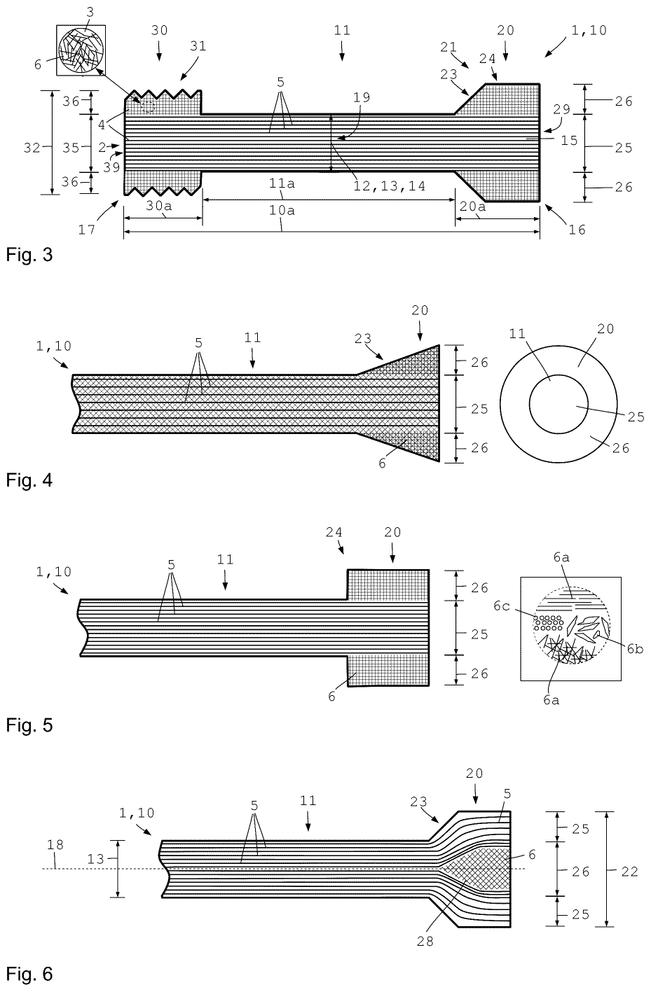

FIGS. 3 to 10 illustrate different wheel components 1 according to the application, configured as spokes 10. FIG. 3 illustrates a cross section of a spoke 10, comprising an elongated center portion 11 and two end portions 20, 30. The spoke 10 is configured integrally overall, and the spoke body 15 has no parting surfaces between the end portions 20, 30 and the center portion 11.

The spoke 10 consists of a fibrous composite material 2 and comprises a matrix material 3 and reinforcing elements 4. Long fibers 5 extend (at least nearly) completely over the length 10a of the spoke 10 centrally through the end portion 30, the center portion 11 and the end portion 20 at the other end of the spoke 10. At the very end, the long fibers 5 may be covered, so as to be invisible from the outside.

Reference is made to the fact that the FIGS. 3-10 depict the wheel component 1 with the spoke 10 not true to scale, so as to more clearly show every part and component of the spoke 10. In reality, the spoke 10 has a length 10a of for example 290 mm or 300 mm and, in a non-aerodynamic configuration, it may for example have a diameter between 1 mm and 3 mm or 4 mm. Other dimensions are likewise possible. These dimensions are also indicated so as to illustrate that the figures are not shown true to scale.

FIG. 3 shows that the end portion 30 has a threaded portion 31 configured as an external thread and extending across the entire width respectively length 30a of the end portion 30. The other end portion 20 has a conical portion 23 adjacent to the center portion 11, and a supporting or cylindrical portion 24 succeeding the conical portion 23 and reaching up to the spoke end.

In simple configurations, the center portion 11 is configured round, so that the minimum transverse dimension 12, the medium transverse dimension 13, and the maximum transverse dimension 14 each show the same value, and presently correspond to the diameter of the center portion 11. In other configurations, the spoke 11 may be configured e.g. aerodynamically, so that the minimum, medium, and maximum transverse dimensions 12-14 are different from one another.

The long fibers 5 extend over the entire length of the spoke 10 as reinforcing elements 4. The long fibers 5 in the end portions 20, 30 are located only in the (central) cross-sectional region 25 at the end portion 20 and the central cross-sectional region 35 at the end portions 30.

The cross-sectional portion 36, which likewise consists of a fibrous composite material 2 and has the same matrix material 3 as the center portion 11, follows the cross-sectional region 35 radially outwardly at the end portions 30.

Unlike the center portion 11 and the cross-sectional regions 25, 35, shorter reinforcing elements are employed in the cross-sectional portions 26, 36, which may consist of short fibers 6a or fiber bits 6b and/or reinforcing particles 6c. In the cross-sectional portions 26, 36 no reinforcing elements at all or only smaller/shorter reinforcing elements may be present.

In simple configurations, short fibers 6a are injection molded to the ends 16, 17, together with a matrix material 3, wherein, at least in this place, the matrix material 23 is first re-plasticated, if it had already (somewhat) solidified. This manufacturing process prevents the forming of separate boundary surfaces or adhesion surfaces or surfaces between the cross-sectional portion 36 and the cross-sectional region 35, inside of the matrix material 3. A transition between the cross-sectional region 35 and for example the cross-sectional portion 36 is adjustable only by modifying the embedded reinforcing material. This results in a particularly high stability under load of the wheel component 1 according to the application.

In the exemplary embodiment according to FIG. 3, the long fibers 5 are located in the central regions 29, 39 of the end portions.

FIG. 4 illustrates a slightly different exemplary embodiment of a wheel component 1 according to the application with a spoke 10, wherein only the end portion 20 and a part of the center portion 11 are depicted.

Unlike FIG. 3, the end portion 20 is configured conical overall. Again, the cross-sectional region 25 is interspersed with long fibers 5, while the cross-sectional portion 26 follows radially outwardly, having the same matrix material 3 but shorter reinforcing elements 6. Again, the end portion 20 forms the head portion 21 of the spoke 10, and serves to support the spoke on the rim or the hub.

As the schematic sketch on the right in FIG. 4 shows, both the center portion 11 and the end portion 20 are configured rotationally symmetrical in the exemplary embodiment according to FIG. 4. Again, it is possible for the center portion 11 to be configured aerodynamically, so that the cross sectional shape deviates from a circular shape.

FIG. 5 shows another variant of a spoke 10 as the wheel component 1, wherein the end portion 20 has no conical portion 23, but only an orthogonally protruding supporting or cylindrical portion 24.

On the right in FIG. 5, some examples of different reinforcing elements 6a, 6b and 6c are shown, which can be employed in the cross-sectional portion 26 at the end portion 20 (and in the cross-sectional portion 36 of the other end portion 30).

Both randomly placed shorter reinforcing elements 6a and unidirectional reinforcing elements 6a in short shapes, and fiber bits 6b in the same or different orientations, and reinforcing particles 6c, may be employed. A combination of different reinforcing elements 6a, 6b and 6c is likewise possible.

FIG. 5 shows only one end portion 20. The other end portion 30 may be configured identically. Alternately, both of the end portions 20, 30 (also) have a threaded portion 31. The shape of one or both of the end portions may be configured as illustrated in FIG. 3, 4 or 5. A wheel may comprise different spokes.

FIG. 6 shows a variant of a wheel component with a spoke 10, wherein, following the pultrusion, the end 16 is melted onto the end portion 20, and a cone-like element is inserted, wherein after removal, the cavity leaves a cone-like portion 28, which is filled up with a fibrous composite material 2 and a matrix material 3 and reinforcing elements 4. Centrally, the cross-sectional portion 26 with shorter reinforcing elements 6 is provided, while the long fibers 5 extend annularly around the cross-sectional portion 26 in the cross-sectional region 25. Overall, the end portion is widened to a diameter 22.

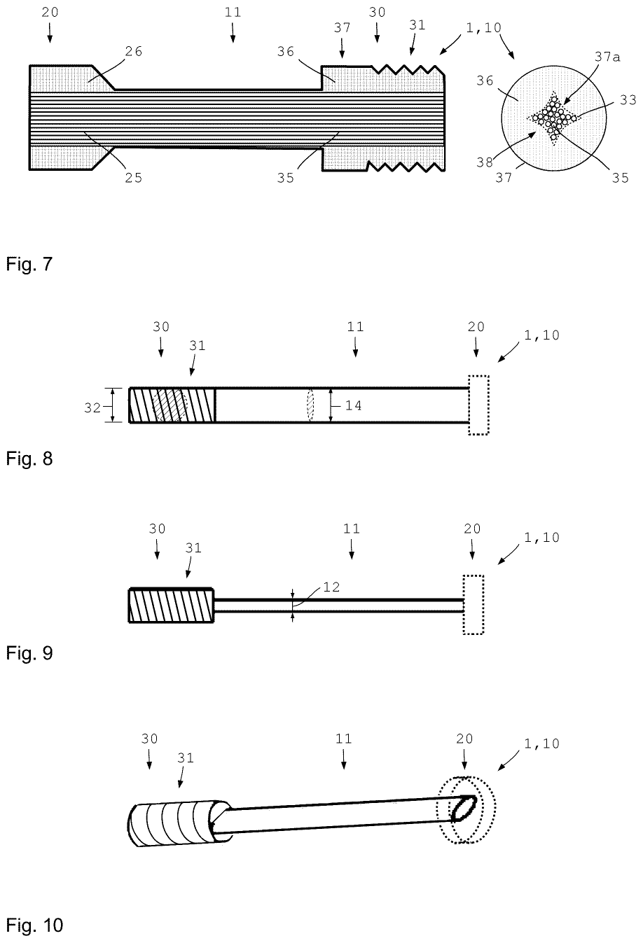

FIG. 7 shows another variant, wherein the end portion 30 is configured longer, respectively wherein the threaded portion 31 does not extend over the entire length of the end portion 30. An end portion 37 follows, configured cylindrically.

In FIG. 7, the long fibers 5 are again provided over the entire length of the spoke 10, virtually extending over the entire length of the end portions 20, 30 and the center portion 11.

FIG. 7 shows on the right a cross section in the end portion 37. One can clearly see that the reinforcing elements 4 disposed in a circle in the center portion 11, take a different cross sectional shape in the end portion 30 (and optionally, also in the end portion 20). Namely, the cross sectional shape is configured non-round, so as to form a deviating cross section 37a, similar to a rectangle, showing inwardly extending bulgings in the side surfaces. The envelope curve 33 drawn in a broken line surrounds the reinforcing elements 4 the closest possible, and it is shown only for illustrating the shape. In reality, this envelope curve does not exist. It is not a separate layer. The spoke body is manufactured of one single material and is one-piece (monobloc). The cross sectional shape may also be referred to as star-shaped. This enables transmission of a higher rotational force, which is an advantage when setting the spoke tension.

Other deviating cross sectional shapes are also possible for the cross-sectional region respectively long fiber region 35, thus, its cross sectional shape may be triangular or oval or T-shaped or V-, or W-shaped or the like.

FIGS. 8-10 illustrate another wheel component with a spoke 10, FIGS. 8 and 9 showing two side views, clearly showing that the spoke 10 is configured aerodynamically, so that the minimum transverse dimension 12 is considerably smaller than the maximum transverse dimension 14 in the center portion 11.

An the ends 16, 17, the spoke 10 is once again configured round on the end portions 20, 30, and is provided with a threaded portion 31 at the end portion 30. The outer diameter 32 on the end portion 30 may correspond to the maximum transverse dimension 14 in the center portion 11.

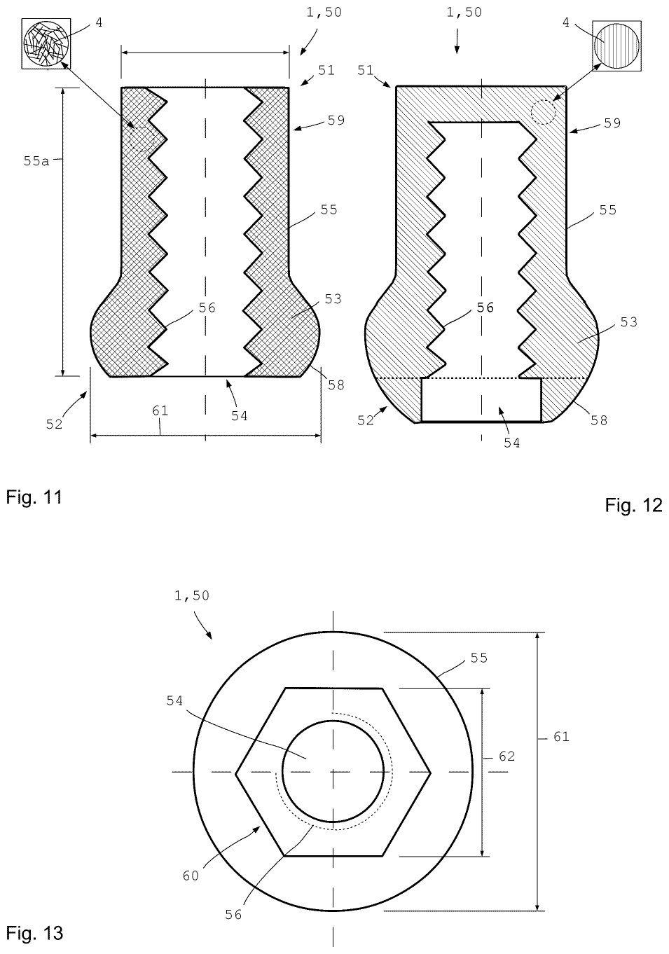

FIGS. 11, 12 and 13 illustrate a wheel component 1 according to the application with a spoke nipple 50. FIGS. 11 and 12 show two slightly different exemplary embodiments, each in cross section.

The spoke nipples 50 consist of a fibrous composite material 2 with a matrix material 3 and reinforcing elements 4. The reinforcing elements 4 may be configured as long fibers 5 or as shorter reinforcing elements 6.

The spoke nipple 50 is provided with a nipple body 55 extending over a length 55a, which may for example be 10 mm. Somewhat shorter and somewhat longer configurations are likewise possible. The nipple body 55 has a length 55a greater than the diameter 61 of the nipple body.

The nipple body is provided with end portions 51 and 52 on the ends 58 and 59. The nipple head 53 is configured rounded at the end 58, providing the contact surface, on which the nipple is for example supported on the rim.

The nipple head 53 is provided with a takeup 54 for the threaded end of a spoke. The takeup is configured with an internal thread 56. The nipple head 53 screws onto a spoke end by way of the thread 56. The takeup 54 may be configured as a through hole. It is also possible for the other end 51 to be partially or completely closed. Then, the takeup 54 is a blind hole.

FIG. 13 shows a top view of the end portion 51 of the spoke nipple 50. Thus, the tool receiving socket 60 with the wrench size 62 can be seen on the nipple body 55. In the center, the takeup 54 can be seen, in which the thread 56 is configured.

Employing spoke nipples 50 of a fibrous composite material provides a lighter-weight spoke nipple, which furthermore also reliably prevents possible contact corrosion between different metals. In particular, when employing reinforcing elements with a glass fiber content, these problems are reliably prevented.

All the configurations achieve a connection with an adhesive bond and of one single material (monobloc). A single and integral piece is provided.

In manufacturing spoke nipples 50, for example 20, 30, 40 or more cavities in a manufacturing mold can be filled concurrently, so that after manufacturing a mold, inexpensive manufacture is possible.

The thread in the wheel components is provided directly in the fibrous composite material.

While particular embodiments of the present wheel component for a bicycle have been described herein, it will be appreciated by those skilled in the art that changes and modifications may be made thereto without departing from the invention in its broader aspects and as set forth in the following claims.

### LIST OF REFERENCE NUMERALS

1 wheel component
2 fibrous composite material
3 matrix material
4 reinforcing elements
5 long fiber
6 shorter reinforcing elements
6a short fibers
6b fiber bits
6c reinforcing particles
7 longitudinal axis
10 spoke
10a length of 10
11 center portion
11a length of 11
12 transverse dimension (minimum)
13 transverse dimension (medium)
14 transverse dimension (maximum)
15 spoke body
16 end
17 end
19 central region
20 end portion
20a length of 20
21 head portion
22 outer diameter
23 conical portion
24 supporting, cylindrical portion
25 cross-sectional region
26 cross-sectional portion
28 cone-like portion
29 central region
30 end portion
30a length of 30
31 threaded portion
32 outer diameter
33 envelope curve
35 cross-sectional region, long fiber region
36 cross-sectional portion, short fiber portion
37 end portion
37a deviating cross section
38 cone-like portion
39 central region
50 spoke nipple
51 end portion
52 end portion
53 nipple head
54 takeup
55 nipple body
55a length
56 thread
58 end (rounded)
59 end (tool end)
60 tool receiving socket
61 diameter
62 wrench size
100 bicycle
101 wheel, front wheel
102 wheel, rear wheel
103 frame
104 fork, suspension fork
105 rear wheel damper
106 handlebar, handle
107 saddle
108 hub
109 rim
111 sprocket assembly
112 pedal crank

1. A wheel component for a vehicle, with a spoke configured straight with a center portion and two end portions, to detachably connect the spoke with a hub and with a rim by means of the end portions, wherein at least one of the two end portions comprises a threaded portion,
wherein the spoke is manufactured from a fibrous composite material and comprises at least one matrix material and reinforcing elements embedded therein, wherein the spoke is formed without loops and eyelets;
the end portions are configured integrally with the center portion, each forming an end of the spoke;
the threaded portion is formed in one piece with the end portion;
and at least some of the reinforcing elements are configured as long fibers, and extend through the entire center portion, and over at least a substantial part of the two end portions; and
at least one end portion comprises a cross-sectional region with long fibers embedded therein as reinforcing elements, and at least one cross-sectional portion without long fibers embedded therein as reinforcing elements.

2. The wheel component according to claim 1, wherein at least one end portion has an outer diameter that is larger than at least one transverse dimension in the center portion and wherein at least one of the end portions comprises a threaded portion which screws to a spoke nipple.

3. The wheel component according to claim 1, wherein at least one end portion has a conical portion adjacent to the center portion and a support portion adjacent thereto.

4. The wheel component according to claim 1, wherein at least one of the end portions comprises a head portion for supporting the spoke.

5. The wheel component according to claim 1, wherein in the cross-sectional portion shorter reinforcing elements are embedded.

6. The wheel component according to claim 1, wherein a considerable part of the cross-sectional region comprises solely long fibers and wherein a considerable part of the cross-sectional portion comprises solely shorter reinforcing elements.

7. The wheel component according to claim 1, wherein a considerable part of the cross-sectional region comprises solely long fibers and wherein a considerable part of the cross-sectional portion does not comprise reinforcing elements.

8. The wheel component according to claim 1, wherein the cross-sectional portion forms a significant share of the cross-sectional area of the spoke in the head portion.

9. The wheel component according to claim 1, wherein at least part of the shorter reinforcing elements is formed by fiber bits or reinforcing particles.

10. The wheel component according to claim 1, wherein the matrix material of the spoke is uniform overall and wherein the spoke is in one piece.

11. The wheel component according to claim 1, wherein the cross-sectional region has a cross section deviating from a rotationally symmetrical cross section in at least one end portion and wherein the deviating cross section is taken from a group of shapes comprising a polygonal, star-shaped, oval, elliptic or conical shape.

12. The wheel component according to claim 1, wherein the cross-sectional portion is centrally accommodated in the end portion and has a cone-like portion.

13. The wheel component according to claim 1, wherein the cross-sectional portion radially surrounds the cross-sectional region, and wherein the cross-sectional portion forms a thickening on the end portion.

14. The wheel component according to claim 1, wherein the cross-sectional region comprises a thermoplastic matrix material and wherein the spoke body comprises a thermoplastic matrix material.

15. The wheel component according to claim 1, comprising a rim and a hub and several separate spokes configured straight, wherein the hub is connected detachably with the rim by means of the spokes and wherein the spokes are supported on the end portions of the spokes.

16. The wheel component according to claim 15, wherein the center portion is aerodynamic in shape.

17. The wheel component according to claim 15, wherein the end portion of the spoke is accommodated at least nearly completely within the rim.

18. The wheel component according to claim 15, wherein the material of the rim comprises a fibrous composite material and/or metal.
